(19) United States
(12) Patent Application Publication
(10) Pub. No.: US 2014/0081692 A1
(43) Pub. Date: Mar. 20, 2014

(54) Methods for Generating a List of Similar Organization Members of an Organization Hierarchy

(71) Applicant: Aaron Bickell, Durham, NC (US)

(72) Inventor: Aaron Bickell, Durham, NC (US)

(73) Assignee: ORGSPAN, INC., Durham, NC (US)

(21) Appl. No.: 14/028,000

(22) Filed: Sep. 16, 2013

Related U.S. Application Data
(60) Provisional application No. 61/701,008, filed on Sep. 14, 2012.

(51) Int. Cl. G06Q 10/06

(52) U.S. Cl. CPC G06Q 10/063118
USPC 705/7.17

(57) ABSTRACT

Methods for generating a list of similar organization members are described. In one embodiment, organization information associated with a plurality of members of an organization may be received. The organization information for each one of the plurality of members may include a first element and a second element. A first weight may be assigned to the first element and a second weight may be assigned to the second element. Finally, a plurality of proximity values may be generated based at least in part on the first weight and the second weight. Each one of the plurality of proximity values may be associated with a different one of the plurality of members.

### CROSS-REFERENCE TO RELATED APPLICATIONS

This application claims priority from U.S. provisional application Ser. No. 61/701,008, filed 14 Sep. 2012, entitled “Methods for Generating a List of Similar Organization Members of an Organization Hierarchy” and herein incorporated by reference.

### FIELD

This invention relates generally to enterprise social media applications, and specifically to methods for generating a list of similar organization members of an organization hierarchy.

### BACKGROUND

Each member of an organization may have many different characteristics such as their skills, certifications, departments, and locations that may be useful for different projects. When a project is starting, a project manager may build a team by selecting a group of organization members having certain characteristics, such as members having a particular skill, or members located in the same office building. Conventional methods for building such teams, however, may be cumbersome and inefficient.

In one conventional solution, a manager may search for perspective team members by using an electronic organization directory. In order to find organization members having a particular skill, such as C++ programming, the manager may search through the electronic organization directory by using a keyword search filter. Such a conventional solution, however, may produce results oblivious to other hidden and/or unapparent characteristics that would be helpful for the team.

Therefore there is a need for better methods to rank and display similar organization members.

### SUMMARY

Embodiments provide methods for generating a list of similar organization members of an organization hierarchy. In one embodiment, a proximity value for each one of a plurality of members of an organization may be generated. The proximity value may be based at least in part on a ranking of a plurality of elements associated with each one of the plurality of members. A request may be received for one or more similar organization members. One or more similar organization members may be determined based at least in part on a comparison of the proximity values. A list comprising the one or more similar organization members may then be communicated.

In a second embodiment, organization information associated with an organization component may be received. A first weight may be assigned to a first element of the organization component, and a second weight may be assigned to a second element of the organization component. A proximity value based at least in part on the first weight and the second weight may be generated.

In a third embodiment, a profile of a first member of the organization is displayed. The profile may comprise a plurality of elements. A list request may be generated for one or more similar organization members. A list of one or more similar organization members may then be displayed. The list of similar organization members may be based, at least in part, on a comparison of a plurality of proximity values, each one of the plurality of proximity values associated with one of a plurality of organization members.

Further embodiments, features, and advantages of the invention, as well as the structure and operation of the various embodiments of the invention are described in detail below with reference to the accompanying drawings.

### BRIEF DESCRIPTION OF THE DRAWINGS

The accompanying drawings, which are incorporated herein and form a part of the specification, illustrate the present invention and, together with the description, serve to explain the principles of the invention and to enable a person skilled in the pertinent art to make and use the invention.

FIG. 1 is a flow chart illustrating a method according to an embodiment.

FIG. 2 is a flow chart illustrating a method according to another embodiment.

FIG. 3 is a flow chart illustrating a method according to another embodiment.

FIG. 4 is a flow chart illustrating a method according to another embodiment.

FIG. 5 is a diagram illustrating a system of according to embodiment.

FIG. 6 illustrates a user interface according to one embodiment.

FIG. 7 illustrates a user interface according to another embodiment.

FIG. 8 illustrates a user interface according to another embodiment.

FIG. 9 illustrates a user interface according to another embodiment.

### DETAILED DESCRIPTION

Embodiments of the invention provide methods for generating a list of similar organization members of an organization hierarchy. An organization hierarchy application may generate a view of an organization member profile in a graphical user interface. Users may benefit from seeing similar organization members to the member profile currently being shown. Embodiments advantageously digest multiple elements of each organization member profile to quickly and intuitively display a list of similar organization members to the one currently being viewed. Each element or characteristic of an employee, such as their department, skills, and experience, may be weighted and used to generate a proximity value for each employee. Such proximity values can be compared across an organization to generate a list of employees with similar characteristics. By individually weighting different employee characteristics to generate a proximity value, a list of similar employees generated from a proximity value comparison may incorporate hidden and/or dynamic analytics that improve the accuracy and usefulness of the list.

In one exemplary embodiment, a client device such as a smart phone or tablet executes an organization hierarchy application that displays a profile of an organization member (i.e. the active organization member) in a graphical user interface. Each organization member may be associated with a plurality of characteristics, or elements, such as department, title, skills, certifications, experience, and location. As a user navigates to a profile for a particular member, the organization hierarchy application may generate a list request for one or more similar organization members to that particular member. Meanwhile, in the embodiment, a server in communication with the organization hierarchy application may have generated a proximity value for each member of the organization. The server may have generated a proximity value by assigning weights to each element of an organization member, and calculating a proximity value for each one of the plurality of members based on the weights. After receiving a request for similar organization members, the server may determine one or more similar organization members by comparing a proximity value of the active organization member with the proximity values of the other organization members. The server may then return a list of similar organization members, with each similar organization member having a proximity value exceeded a predetermined proximity threshold.

### Illustrated Methods

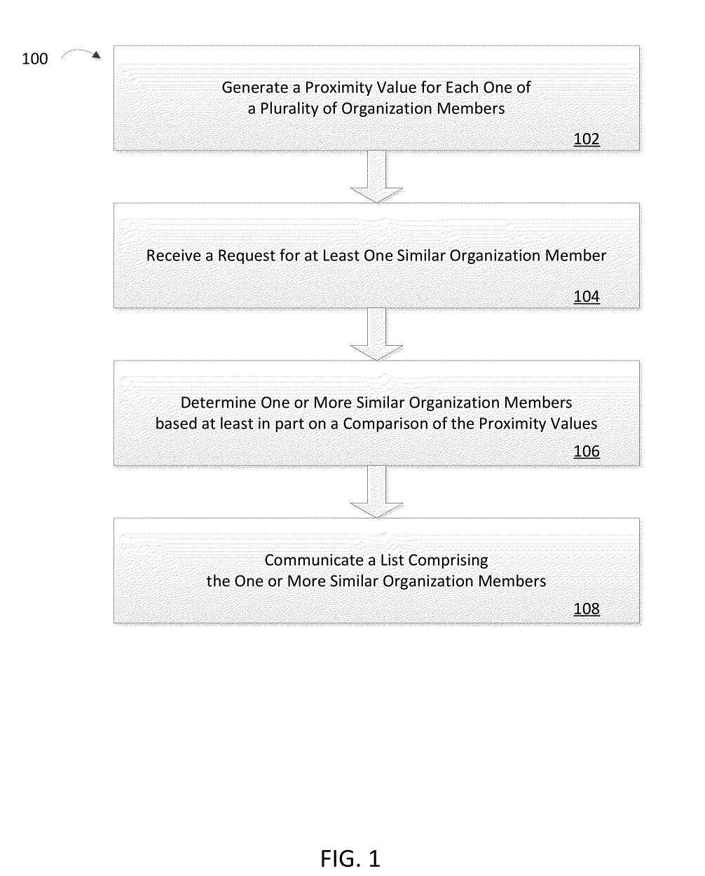

In various embodiments, a list of similar organization members may be displayed in a graphical user interface generated by an organization hierarchy application. FIG. 1 illustrates a flow diagram of method 100 according to one embodiment. In step 102 of method 100, a proximity value for each one of a plurality of organization members is generated. A proximity value may be a feature vector, or a numerical representation of one or more elements of an organization component.

A proximity value may be generated for an organization member, such as an employee, volunteer, and/or team director. In other embodiments, a proximity value may be generated for other types of organization components, such as a planning or strategic component (e.g. organization goals, organization objectives, etc.). In another embodiment, a proximity value may be generated for potential organization members, for example, job applicants.

A proximity value may be generated for each member of an organization. In one embodiment, each proximity value may be unique, and therefore each organization component may have a unique proximity value. In a second embodiment, two or more proximity values may be the same.

In other embodiments a proximity value may not be generated for some organization components. As examples, temporary organization components such as draft goals, draft objectives, temporary employees, or hypothetical team members, may not be associated with a proximity value. If an organization component is not associated with a proximity value than that component may be hidden from a determination of similar organization components, and may not appear in a similar organization component list.

In some embodiments, a proximity value may be generated for an organization component, but manually or automatically be deleted at a later time. For example, a proximity value may be scheduled to automatically expire, and recalculated for an organization component.

A proximity value may also be associated with a permission level. In one example, a proximity value may be visible to a department head or manager, but hidden from a lower-level organization member. By assigning a permission level to a proximity value, lists of similar members based on a comparison of proximity values may differ according to a user's permission level. In the example, a department head with broader access permissions may be able to view similar employees across an organization, while a team member with narrower access permissions may only be able to view similar employees across a team or department.

In step 104, a request for at least one similar organization member is received. An organization hierarchy application may generate the request. The request may be received from a local or remote client device, such as a web browser, smart phone, or tablet. A request may be automatically or manually generated.

In one embodiment, an organization hierarchy application generates and displays an organization hierarchy, including one or more component profiles. Each component profile may correspond to an organization component, such as an organization member. As a profile of an organization component is displayed in a graphical user interface, the organization hierarchy application may generate a request for similar organization components, such that a list of similar organization components may automatically appear in the graphical user interface alongside the active profile, without any additional user intervention. In another embodiment, a user may manually request to see a list of similar organization components, for example, by clicking on a button, or hovering a cursor over a profile.

A request for at least one similar organization member may be associated with an active organization component, such as a member profile or planning component currently being displayed by an organization hierarchy application. The similar list request may comprise an identifier associated with the organization component being actively displayed. Identifiers may include, for example and without limitation, a unique user id, an email address, or a proximity value of the member associated with a profile being displayed by an application.

In step 106, one or more similar organization members are determined. The determination of similar organization members may be based on a comparison of proximity values. A similar or matching proximity value may indicate that two members of an organization are proximately or closely related. In contrast, two divergent proximity values may indicate that two members of an organization are dissimilar, or not proximately related.

In one embodiment, the calculation of a proximity value through the weighting of individual elements generates a proximity value that reflects the relative significance of some component elements. Thus, a comparison of proximity values for different members may reveal how proximate, or how similar, a first organization member is with one or more other organization members according to the most significant elements of an organization member, such as their skills or experience.

In one embodiment, some or all of the members of an organization are associated with a proximity value. A request for organization members similar to a first organization member (for example, an active organization member being displayed by an organization hierarchy application) may be received. One or more similar organization members may be determined by comparing a proximity value associated with the first organization member against proximity values associated with other members of the organization.

The determination of a similar member may be based on a threshold similarity. A threshold similarity may comprise a minimum relevancy, or similarity, between two organization members. In one embodiment, the comparison of proximity values comprises determining whether a first proximity value of a first organization member and a second proximity value of a second organization member exceeds a predetermined threshold. A threshold similarity may comprise a score, such as a relevancy score. Scores may be boosted to temporarily or permanently alter a determination of threshold similarity. In one alternative, a threshold similarity may comprise a predetermined percentage, i.e. 50%, 60%, 70%, 90% of similarity between two proximity values. For example, a similar member list may include members that are at least 70% similar to the active member profile, as measured by a comparison of the proximity value of the active member to the proximity values of other members of the organization.

In step 108, a list comprising the one or more similar organization members is communicated. The list may be communicated from a server to a client device, such as a device executing an organization hierarchy application. In one embodiment, the list may comprise a plurality of similar organization members. In another embodiment, the list may comprise a single similar organization member.

The maximum size of the list may be limited to a predetermined number. For example, a similar member list may comprise no more than five, ten, or fifty members. A limited-size list may comprise only the most similar members of an organization, or in one alternative, the first sufficiently similar members found. Limiting the size of a list of similar organization components may result in faster generation of the list. An unlimited similar organization component list may comprise a list of all organization components arranged by similarity to the active organization component.

The similar member list may be based at least in part on the similar list request and a comparison of proximity values. In one example, an application notifies a server of a profile of a first member currently being displayed by sending a similar list request associated with the first member. The server may use the similar list request to determine a first proximity value associated with the first member and compare the first proximity value with proximity values associated with one or more other members of the organization.

Additional factors may be used for generating a list of similar employees. An application executing on a local device may detect one or more conditions to generate a more relevant list. As one example, an organization hierarchy program operating on a client device may detect a location of device user. If the location of the device is the same as an active employee profile (e.g. the same floor, building, or city), than this proximity condition may be used to update a list of similar employees with more or less emphasis on the location element of the employee. The organization hierarchy program may communicate a request for similar employees along with the device location to the server, which then updates the weight of a location element in a similar employee determination.

A list of similar members may be used to sort through a list of eligible candidates for a job. For example, a proximity value may be assigned to each job applicant. A user may look for job applicants most closely resembling a current team member, or in one alternative, a job applicant most closely resembling an ideal candidate with particular skills, experiences, or other pertinent elements.

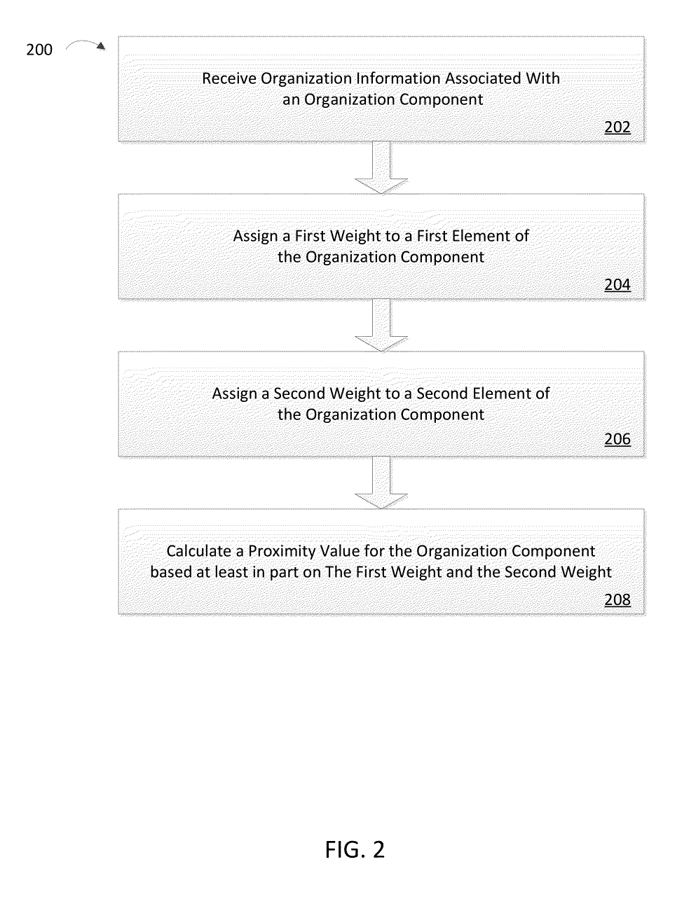

FIG. 2 illustrates a flow diagram of method 200 according to one embodiment. In step 202 of method 200, organization information associated with an organization component is received. A server may receive organization information from one or more sources, such as an organization directory service (e.g. Active Directory database) or a client device.

Organization information may comprise information associated with a plurality of components and/or a plurality of elements. In one embodiment, the organization information may comprise a first element and a second element. Examples of elements includes a hierarchy level, picture, title, department, division, status, reporting manager, biography, skills, certifications, work experience, office location, email address, phone number, chat id, and/or an assistant information.

A weight may be assigned to each element of the organization information. In step 204, a first weight is assigned to a first element of the organization component, and in step 206, a second weight is assigned to a second element of the organization component. A server may assign the first weight to the first element and the second weight to the second element of the organization component.

Two or more elements may be assigned the same weight, while other elements may be assigned different weights. For example, email address, phone numbers, and instant message ids may all be assigned the same weight, while certifications and skills are assigned different weights. In another embodiment, each element may be assigned a different weight. For example, a skills element may be assigned a first weight, while an office location element may be assigned a second weight different than the first weight.

In order to generate more accurate and useful similar member lists, higher weights may be assigned to elements that are determined to be more significant, while lower weights may be assigned to elements that are determined to be less significant. For example, a server may determine that the skills and experience fields are relatively significant, whereas the name, email address, and office phone number fields are relatively insignificant. In the example, the more significant skills and experience fields may be weighted heavily, or higher, while the less significant name, email address, and office phone number elements are weighted lighter, or lower.

In step 208, a proximity value is calculated for the organization component based at least in part on the first weight and the second weight. A proximity value may be a feature vector, or a numerical representation of one or more elements of an organization component.

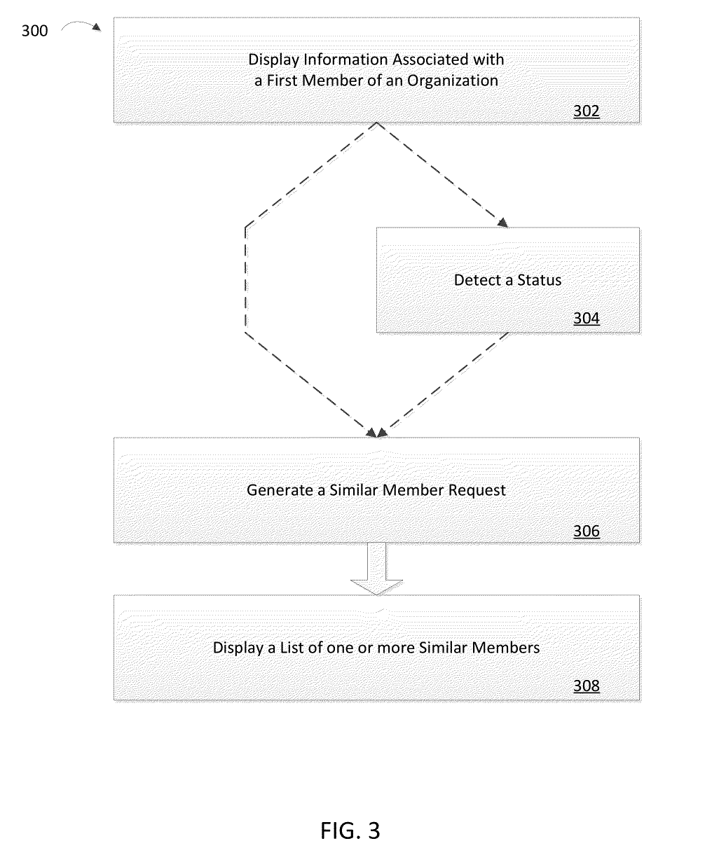

FIG. 3 illustrates a flow diagram of method 300 according to one embodiment. In step 302 of method 300, information associated with a first member of an organization is displayed. The information may be displayed in a graphical user interface generated by an organization hierarchy application. An organization hierarchy application may display organization information in the form of profiles, such as member profiles. Illustrations of embodiments of a graphical representation of a member profile are described in detail below and shown in the figures.

A profile of an organization component, such as an organization member profile, may show various information associated with that member, in the form of one or more elements. For example, a member profile may show a name, title, department, location, and status of a member. Other elements associated with the member and shown in a member profile may include a member picture, skills, education, experience, biography, or location. A profile of a goal or objective may show the author, start date, target completion date, and completion percentage of the goal.

In optional step 304, a status is detected. An organization hierarchy application executing on a local client device may detect a status of the user and/or the device. Examples of a status of an organization member include active, inactive, unavailable, away, offline. Examples of a status of a goal include in progress, incomplete, idle, complete, or abandoned.

Status about a user may be detected based on a user's interactions with a client device and/or organization hierarchy application. For example, a client device may detect its location as the home of the current user. The organization hierarchy application may update a location element of the current user to reflect their current location, for example, to show “at home” or “away from the office.”

In step 306, a similar member request is generated. A similar member request may be automatically or manually generated. In one embodiment, an application displays an active member profile in an enlarged view. The application may automatically generate a similar list request associated as an active member profile is displayed, and communicate the similar list request to a server.

The similar list request may comprise an identifier associated with the displayed member profile. In some embodiments, the similar list request may comprise an identifier uniquely associated with a member profile being displayed. For example, the similar list request may comprise a member name, a user id, and/or an employee number uniquely associated with a member profile being displayed. In other embodiments, the similar list request may comprise a non-unique identifier. For example, one or more members may have the same proximity value. Thus, a similar list request comprising a proximity value may not be unique to that member.

In step 308, a list of one or more similar members is displayed. The list may be generated based at least in part on a comparison of proximity values associated with each one of a plurality of organization members. A server may generate the list of one or more similar members, or in one alternative, the list of one or more similar members may be generated locally. The list of similar members may be displayed alongside an active member profile, and may be displayed as abbreviated or collapsed member profiles.

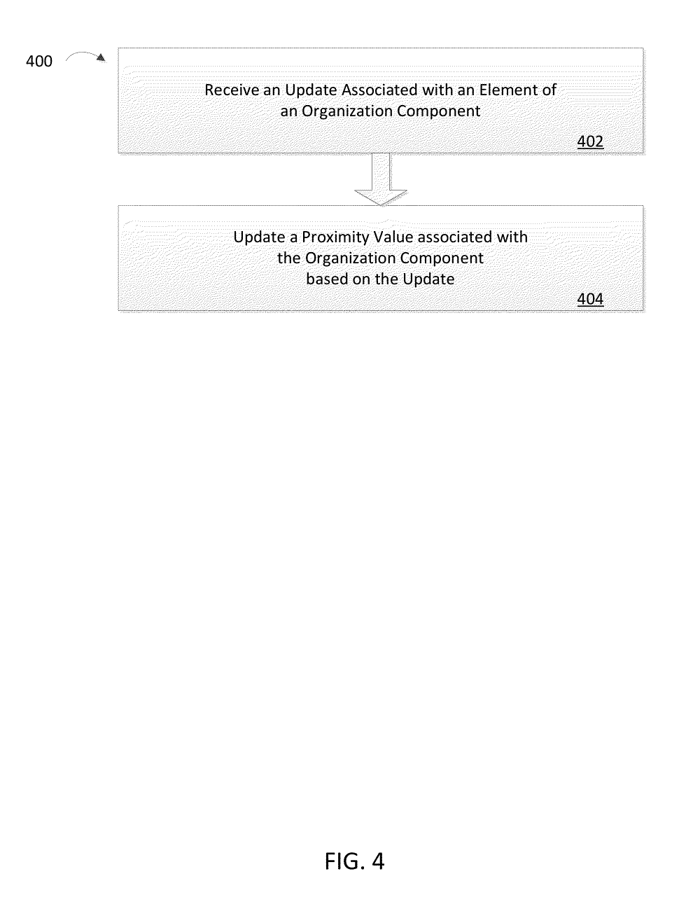

Because information associated with a member may change, there may be a need to update or generate new proximity values. FIG. 4 illustrates a flow diagram of method 400 according to one embodiment. In step 402 of method 400, an update associated with an element of an organization component is received. An update may comprise a change in status, such as a change in the completion percentage of a project, or an employee shifting from “away on vacation” to “available” or “busy.” Examples of other updates my include a change in department, change in location, added experience, added skills, and/or added certifications.

In step 404, a proximity value associated with the organization component is updated based on the element update. In one embodiment, a change in an element may precipitate, or trigger, an update to a proximity value. For example, a server may detect that an organization member has new skills, or updated experience. Each changed or updated element may trigger the server to generate a new proximity value for the organization member.

Proximity values may be updated and/or communicated on a regular basis, such as every 15 minutes, every hour, every day, or every other week. Alternatively proximity values may be updated and/or communicated on an irregular basis, such as every time an application is loaded on a mobile device, or every time an application displays a particular contact or hierarchical level.

In one embodiment, a proximity value may be temporarily changed. A boost and/or penalty may be applied to one or more proximity values at the time a request for similar organization components is received. A boost may increase one or more proximity values for that request alone, for a number of requests (e.g. the next two requests, the next five requests), for a particular time (e.g. one hour, one day, etc.), or for some other period. In one example, a boost may be applied to one or more elements and/or one or more weights. A request may be received for a similar member from a client at a particular location. The weight applied to the location element of each organization member may be temporarily boosted, such that the proximity values of organization members at or near the client location are boosted, or increased.

### Illustrated System

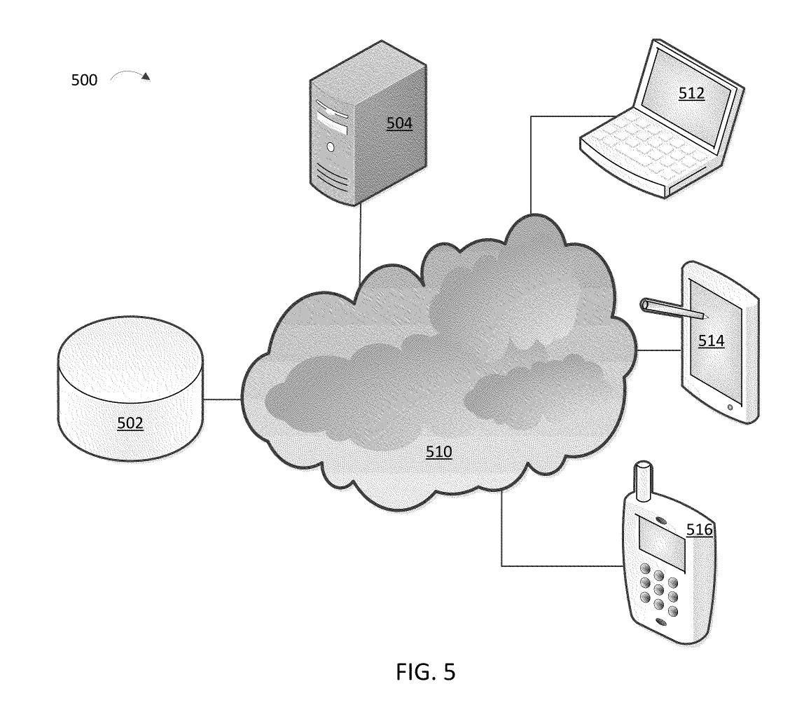

FIG. 5 is a diagram of a system 500 according to another embodiment. As shown in system 500, client devices 512, 514, 516 may be in communication with server 504 over network 510. Server 504 and/or client devices 512, 514, 516 may also be in communication with database 502.

Server 504 may receive organization information associated with a plurality of members of an organization. Server 504 may receive organization information from a variety of sources, such as database 502 or client devices 512, 514, 516. In one embodiment, database 502 may be a directory database, such as an Active Directory database, maintained by an organization and storing organization information related to some or all of the members of an organization.

Organization information received by server 504 may include a plurality of elements, including and without limitation, a picture element, a title element, a department element, a division element, a status element, a reporting manager element, a biography element, a skills element, a certifications element, a work experience element, a location element, an office location element, an email address element, a phone number element, a chat address element, and/or an assistant information element. In other embodiment, server 504 may receive organization information including other elements.

Server 504 may assign a weight to each element. In one embodiment, server 504 may assign a first weight to a first element of the organization information, and assign a second weight to a second element of the organization information.

Server 504 may generate a plurality of proximity values based at least in part on weights assigned to one or more elements. In one embodiment server 504 generates a proximity value for each member of the plurality of members in the organization information.

As shown in FIG. 5, client devices include laptop computer 512, tablet 514 and smart phone 516. In other embodiments, other types of client devices may be used. For example, a computer integrated with a car may be used. Each client device 512, 514, 516 may be configured to communicate via one or more types of communication. For example, tablet 514 may be used to video chat, email, and text message. Smart phone 516 may be used to email, text message, and place telephone calls. Laptop computer 512 may be used to video chat, email, and instant message. Client devices 512, 514, 516 may be configured to utilize other types of communication such as social networking (e.g. LinkedIn, Twitter) and online forums.

Client devices 512, 514, 516 may execute an organization hierarchy application that may generate a graphical user interface. An organization hierarchy application may comprise a native mobile device application such as an iOS iPad application, a Windows Phone application, or an Android application. As one alternative, the application may comprise a non-native application such as a web application accessed through a web browser, for example from a desktop computer or a laptop.

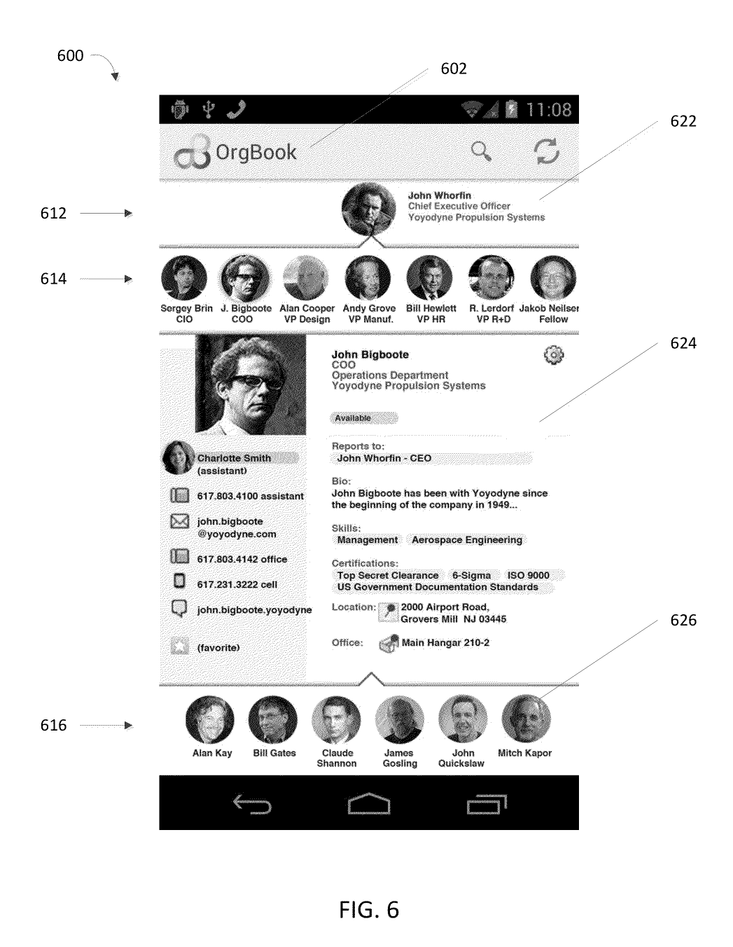

An organization hierarchy application executing on a client device may display organization information received from a database 502 by server 504. A user may view an organization hierarchy by logging in to an organization hierarchy application executing on a client device. An organization hierarchy application executing on client devices 512, 514, 516 may display information about one or more members of an organization. For example, in the embodiment illustrated in FIG. 6, an organization hierarchy application displays a plurality of member profiles. Client devices 512, 514, 516 may also display a list of similar members to a member displayed in the graphical user interface.

An application executing on client device 512, 514, 516 may notify server 504 of a profile being displayed or viewed by a user (e.g. an active profile). While a user navigates through an organization hierarchy to view one or more profiles, the organization hierarchy application may notify the server of the current member profile being viewed by the user. In one embodiment, an organization hierarchy application displays an active profile of an organization member. At substantially the same time a profile is displayed (immediately before, during, or after display of a profile), the organization hierarchy application may communicate a value such as a member user id or a proximity value associated with the profile to server 504. Server 504 may receive the value and utilize the received value to generate a list of similar members.

Server 504 may generate a similar member list by comparing a proximity value associated with a first member of an organization with a plurality of proximity values associated with one or more other members of the organization. A similar member list may comprise zero, one, or a plurality of members of an organization. The list of similar members may be communicated from server 504 to a client device, and displayed in an organization hierarchy application.

### Illustrated Screenshots

FIG. 6 illustrates a user interface according to one embodiment. As shown in screenshot 600, organization hierarchy application 602, is displayed in a graphical user interface. In FIG. 6, organization hierarchy application is embodied as an Android application. In other embodiments, the application may comprise other types of mobile or desktop applications, such as an iOS iPhone application, an iOS iPad application, a windows mobile application, a windows phone application, or a web application. Embodiments of an organization hierarchy application are further described in related U.S. Provisional Application No. 61/656,322, file 6 Jun. 2012 and entitled “METHODS AND SYSTEMS FOR INTEGRATED SOCIAL MEDIA, STRATEGY, AND ORGANIZATIONAL HIERARCHY.”

An organization hierarchy application may display information about one or more members of an organization. An organization member may be represented in the organization hierarchy application as a profile. A profile may be associated with a person, such as a member of an organization or a potential client. As one alternative, a member profile may be associated with another organization, such as a government agency or a supplier, or a resource, such as a printer, a server, or a meeting room.

The organization hierarchy application may display profiles in a variety of forms, or views, such as in an expanded or a collapsed view. The user interface illustrated in FIG. 6 is shown displaying a plurality of member profiles, including first member profile 622, shown in a first collapsed view, second member profile 624, shown in a first expanded view, and third member profile 626, shown in a second collapsed view.

In a collapsed view of a member profile, limited information about the profile may be shown, such as the member's picture and name. First member profile 622, shown in one embodiment of a collapsed view, displays the first member's name, title, and division. Third member profile 626, shown in another embodiment of a collapsed view, displays the third member's name. In other embodiments, a collapsed view may show more or less information about a member.

An expanded view of a member profile may display more information, or details, about a member than a collapsed view. In FIG. 6, member profile 624 is shown in an expanded view and displays the first member's name, picture (e.g. a headshot or a candid photo), title, department, division, status, reporting manager, biography, skills, certifications, work experience, location, office location, email address, phone number, chat address, and assistant information (e.g. assistant picture, assistant name, assistant title, assistant phone number, assistant email address). Information displayed in a profile may be directly related to the organization, such as a start date for joining the organization, or other types of information, such as the number of children a member has, a personal cellular phone number, or other types of information.

As shown in FIG. 6, second member profile 624 is displayed in an expanded view by the organization hierarchy application. Second member profile 624 comprises a picture, name, title, department, division, status, reporting manager, biography, skills, certifications, location, office location, email address, office phone number, mobile phone number, chat address, and assistant information (assistant picture, assistant name, assistant title, assistant phone number, assistant email address). Information associated with a member and shown in a member profile may be presented in a variety of formats. Some information, such as a member name or title, may be presented as text fields. Other information, such as a member status (e.g. active, inactive, unavailable, away, offline, etc.) may be presented through coloring or shading. For example, a picture and/or profile of a member who is inactive or offline may be displayed in a lighter tone (e.g. grayed out) or with a different background color (e.g. red, purple, etc.)

Profiles displayed by organization hierarchy application 602 may be active or inactive profiles. An active profile may be displayed differently than an inactive profile. In one embodiment, an active profile is shown in expanded view, while inactive profiles are shown in collapsed view. An organization hierarchy application may display any combination of active profiles and inactive profiles. In one embodiment illustrated in FIG. 6, second member profile 624 is shown in expanded view and is an active profile, while first member profile 622 and third member profile 626 are shown in collapsed view and are inactive profiles.

In one embodiment, one or more active member profiles may comprise links that may trigger actions, such as launching an external program. For example, a cell phone number shown in an active member profile may be clicked, or activated, and trigger a phone application to open in a mobile device executing the organization hierarchy application. In the embodiment, one or more inactive member profiles may not comprise links that trigger actions. For example, an inactive profile may not display a link for launching a phone application or email application.

In another embodiment, an inactive profile may comprise the same functionality as an active profile (e.g. include the same links), but be displayed differently. For example, an active profile may be displayed in full color and/or full resolution, while inactive profiles are displayed in grayscale and/or lower resolution. Visual and functional distinctions between an active profile and an inactive profile may help a user understand the contextual relationship between a plurality of profiles shown in the same view of the user interface. Because an active profile may include active links, or be visualized differently than an inactive profile, a user may understand that different organizational hierarchy relationships are shown with respect to the active profile, and not with respect to the inactive profile.

An organization hierarchy may comprise one or more organization hierarchy levels. The organization hierarchy application may display a plurality of organization member profiles arranged according to their respective associated organization hierarchy level. For example, as shown in FIG. 6, the organization hierarchy application displays a first organization hierarchical level 612 in an upper section of the user interface, a second organization hierarchical level 614 in a middle section of the user interface, and a third organization hierarchical level 616 in a lower section of the user interface. The spatial relationship between profiles and hierarchical levels may provide contextual information to users about the relationship between different members and/or different hierarchical levels. Each organization hierarchical level may comprise one or more members. In some embodiments, a profile of each member of the corresponding organization hierarchical level is displayed. In other embodiments, only a portion of an organization hierarchical level may be shown.

An organization hierarchy may be navigated by scrolling up and down, to display different organization hierarchy levels, or left and right, to display different members of the same organization hierarchical level. In other embodiments, an organization hierarchy may be navigated in other manners.

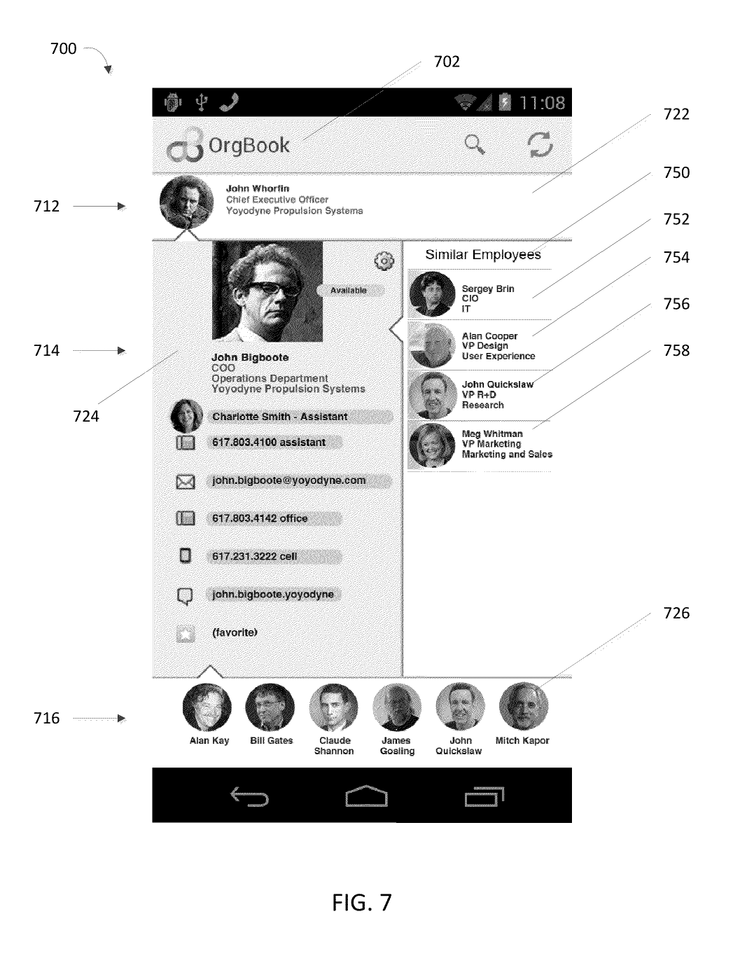

As a user navigates an organization hierarchy, views of different organization component profiles may be displayed. FIG. 7 illustrates a user interface according to another embodiment. As shown in screenshot 700, an organization hierarchy application 702 generates a second view of an organization hierarchy in a graphical user interface. The second view comprises first organization hierarchical level 712 in an upper section of the user interface, second organization hierarchical level 714 in a middle section of the user interface, and third organization hierarchical level 716 in a lower section of the user interface.

First organization hierarchical level 712 comprises first member profile 722, shown in a collapsed view. Second organization hierarchical level 714 comprises second member profile 724, shown in an expanded view. Third organization hierarchical level 716 comprises a plurality of third hierarchical level profiles, including third member profile 726 shown in a collapsed view.

As shown in FIG. 7, the graphical user interface also displays a list of similar organization members, illustrated as similar employees list 750. Similar employees list comprises similar employee profiles 752, 754, 756, 758. Each similar employee profile 752, 754, 756, 758 is displayed in a collapsed view comprising the employee picture, name, title, and department. In other embodiments, other information may be displayed by each profile in the list of similar organization members.

A list of similar members may include zero, one, or more members. If no similar members are found, or if no members having a proximity value exceeded a predetermined threshold of similarity are found, than the organization hierarchy application may display a notification to that effect, e.g. “no similar members found.” In one embodiment, a list of similar members may only include members in the same hierarchical level as the active profile. In other embodiments, a list of similar members may include members across a plurality of hierarchical levels in an organization.

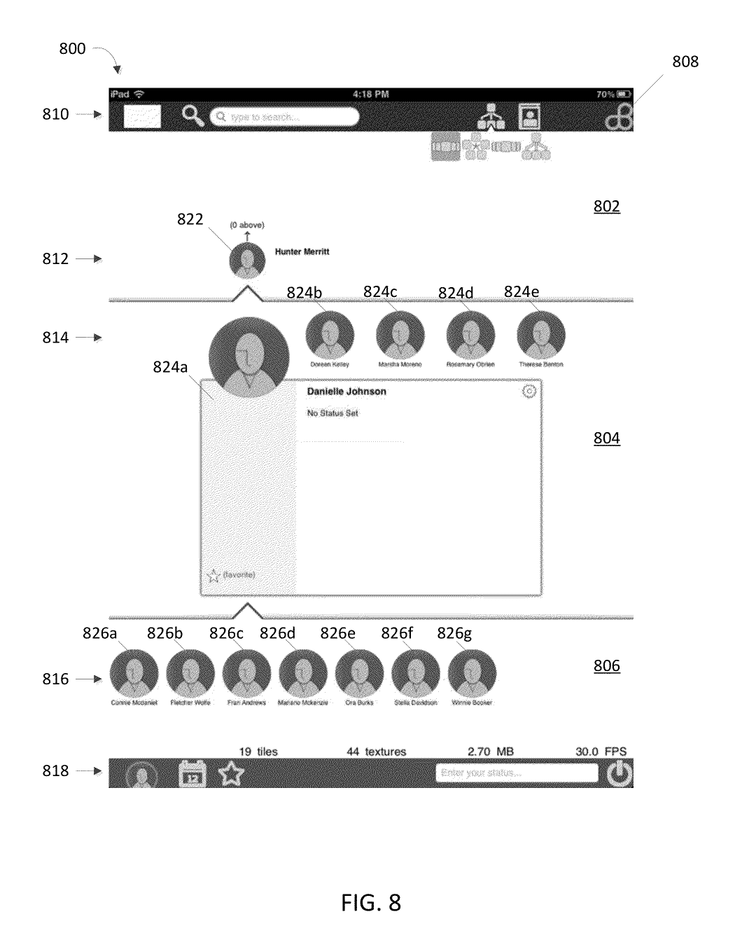

FIG. 8 illustrates a user interface according to another embodiment. Screenshot 800 illustrates a first view of application 808 within a graphical user interface. As shown in screenshot 800, application 808 comprises an iOS application displayed in a portrait view. In other embodiments, the application may be viewed in a landscape view, or in some other view.

Application 808 may comprise an organization hierarchy application that may display one or more member profiles according to one or more organization hierarchy levels. In screenshot 800, application 808 displays first hierarchical level 812 in first region 802 of the user interface, second hierarchical level 814 in second region 804 of the user interface, and third hierarchical level 816 in third region 806 of the user interface. As shown by screenshot 800, regions 802, 804, 806 divide the graphical user interface in a columnar format, with first region 802 occupying a top portion of the user interface, second region 804 occupying a middle portion of the user interface, and third region 806 occupying a lower portion of the user interface. In other embodiments, other graphical arrangements of the regions may be shown. In still other embodiments, a user interface may display one, two, or a plurality of hierarchical levels in one, two, or a plurality of regions of the user interface. In one example, an application displays two organization hierarchical levels in an upper region and a lower region. In another example, an application displays three organization hierarchical levels in a left region, a middle region, and a right region of the user interface. Application 808 may include other aspects, such as a first perspective navigation bar 810 and second perspective navigation bar 818.

In the illustrated screenshot 800, first level member profile 822 is displayed in first region 802, and may correspond to first hierarchical level 812. A plurality of second level member profiles 824a, 824b, 824c, 824d, 824e are displayed in second region 804, and may correspond to second hierarchical level 814 of the organization. A plurality of third level member profiles 826a, 826b, 826c, 826d, 826e, 826f, 826g are displayed in third region 806, and may correspond to third hierarchical level 806 of the organization.

Application 808 may show more details about one or more member profiles by displaying one or more member profiles in an expanded view format. In an expanded view format, a plurality of elements associated with a member may be visible. As illustrated by FIG. 8, second level member profile 824a is shown in an expanded view, which second level member profiles 824b, 824c, 824d, 824e are shown in a collapsed view. A member profile shown in an expanded profile may be referred to as the active member profile.

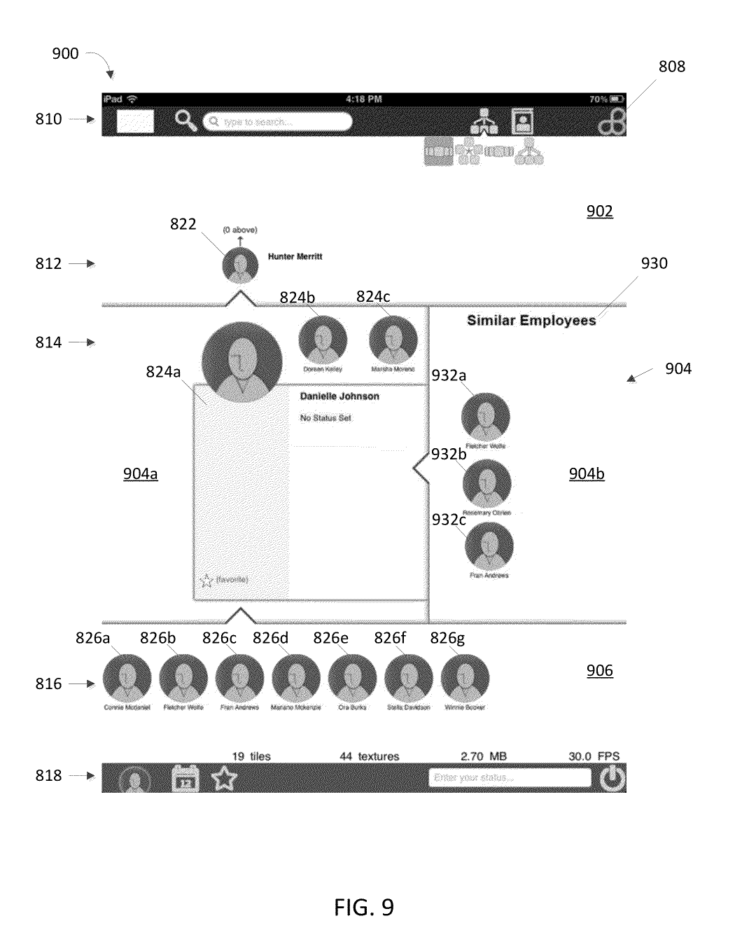

FIG. 9 illustrates a user interface according to another embodiment. Screenshot 900 illustrates a second view of application 808 within a graphical user interface. Application 808 may display a similar member list, illustrated in FIG. 9 as similar employee list 930.

As shown in screenshot 900, middle region 904 of the user interface is divided into two adjacent sections: left sub-region 904a and right sub-region 904b. In other embodiments, a user interface may be divided into different number of regions and/or different numbers of sub-regions. In left sub-region 904a, second level member profile 824a is displayed in an expanded view, while second level member profiles 824b, 824c are displayed in a collapsed view.

Similar employee list 930 is displayed in right sub-region 904b and comprises three similar member profiles 932a, 932b, 932c. Similar members may belong in the same or different hierarchical level as the active member profile. In the embodiment shown in FIG. 9, similar member profiles 932a, 932c each belong to third hierarchical level 816, while similar member profile 932b belongs to second hierarchical level 814.

Similar member list 930 may comprise zero, one, or a plurality of member profiles. Member profiles displayed in similar member list 930 may be formatted according to various views. In the embodiment shown in FIG. 9, similar member profiles 932a, 932b, 932c are displayed in a collapsed view, depicting only member names and member pictures. In other embodiments, profiles shown in similar member list 930 may comprise other information, such as departments, titles, and/or status.

### Scope

Embodiments of a subset or all and portions or all of the above may be implemented by program instructions stored in a memory medium or carrier medium and executed by a processor. A memory medium may be a transitory medium or non-transitory medium. A memory medium may include any of various types of memory devices or storage devices. The term “memory medium” is intended to include an installation medium such as a Compact Disc Read Only Memory (CD-ROM) floppy disks, tape device, a computer system memory or random access memory such as Dynamic Random Access Memory DRAM Double Data Rate Random Access Memory DDR RAM Static Random Access Memory SRAM Extended Data Out Random Access Memory EDO RAM Rambus Random Access Memory RAM etc. or a non-volatile memory such as a magnetic media e.g. a hard drive or optical storage. The memory medium may comprise other types of memory as well or combinations thereof. In addition the memory medium may be located in a first computer in which the programs are executed or may be located in a second different computer that connects to the first computer over a network such as the Internet. In some instances the second computer may provide program instructions to the first computer for execution. The term memory medium may include two or more memory mediums that may reside in different locations e.g. in different computers that are connected over a network.

In some embodiments a computer system at a respective participant location may include a memory medium s on which one or more computer programs or software components according to one embodiment of the present invention may be stored For example the memory medium may store one or more programs that are executable to perform the methods described herein The memory medium may also store operating system software as well as other software for operation of the computer system.

Modifications and alternative embodiments of one or more aspects of the invention may be apparent to those skilled in the art in view of this description. Accordingly this description is to be construed as illustrative only and is for the purpose of teaching those skilled in the art the general manner of carrying out the invention. It is to be understood that the forms of the invention shown and described herein are to be taken as embodiments. Elements and materials may be substituted for those illustrated and described herein, parts and processes may be reversed, and certain features of the invention may be utilized independently, all as would be apparent to one skilled in the art rely after having the benefit of this description of the invention. Changes may be made in the elements described herein without departing from the spirit and scope of the invention as described above and below.

What is claimed is:

1. A method for generating a list of similar organization members, comprising:
generating a proximity value for each one of a plurality of members of an organization, the proximity value based at least in part on a ranking of a plurality of elements associated with each one of the plurality of members;
receiving a request for one or more similar organization members;
determining one or more similar organization member based at least in part on a comparison of the proximity values; and
communicating a list comprising the one or more similar organization member.

2. The method of claim 1, further comprising:
receiving organization information associated with the plurality of members of the organization.

3. The method of claim 1, wherein generating a proximity value comprises:
assigning a first weight to a first element of the plurality of elements;
assigning a second weight to a second element of the plurality of elements; and
calculating a proximity value for each one of the plurality of members based on the first weight and the second weight.

4. The method of claim 3, further comprising:
receiving a first weight adjustment associated with the first element of the plurality of elements;
modifying the first weight;
updating the proximity value for each one of the plurality of members based at least in part on the modified first weight.

5. The method of claim 3, further comprising:
determining the first weight based at least in part on a condition detected by an organization hierarchy application.

6. The method of claim 1, further comprising:
receiving an update to an element associated with an organization member; and
updating a proximity value associated with the organization member based on the update.

7. The method of claim 1, wherein an organization hierarchy program generates the request for one or more similar organization member.

8. The method of claim 1, wherein each one of the plurality of members is associated with at least one element from the list of an hierarchical element, a department element, a title element, a skills element, a certification element, a start date element, an experience element, or a location element.

9. The method of claim 1, wherein each proximity value comprises a numerical representation of the plurality of elements associated with each one of the plurality of organization members.

10. A method for generating a list of similar components of an organization, comprising the steps of:
receiving organization information associated with an organization component;
assigning a first weight to a first element of the organization component;
assigning a second weight to a second element of the organization component; and
calculating a proximity value for the organization component based at least in part on the first weight and the second weight.

11. The method of claim 10, wherein the organization component comprises a first organization component and the proximity value comprises a first proximity value, and further comprising:
receiving a similar organization component request associated with a second organization component;
determining a second proximity value of the second organization component; and
determining whether the first proximity value and the second proximity value exceed a predetermined threshold of similarity.

12. The method of claim 11, further comprising:
generating a similar component list comprising one or more organization components of a plurality of organization components that exceed the predetermined threshold of similarity.

13. The method of claim 10, wherein the organization component comprises an organization member or organization goal.

14. A method for displaying a member of an organization and a list of similar members in the organization, the method comprising:
displaying information associated with an organization member, the information comprising a plurality of elements;
generating a similar member request for one or more similar organization members; and
displaying a list of one or more similar organization members, the list of similar organization members based at least in part on a comparison of a plurality of proximity values, each proximity value associated with one of a plurality of organization members.

15. The method of claim 14, further comprising:
detecting a status, wherein the list request comprises the status, and wherein the list of similar organization members is further based at least in part on the status.

16. The method of claim 15, wherein the status comprises a location, a calendar status, or a profile update.

17. The method of claim 15, further comprising:
updating a proximity value associated with the organization member based at least in part on the status.

18. The method of claim 14, further comprising:
sorting the list of one or more similar organization members.

19. The method of claim 18, wherein the list is sorted by similarity with the organization member.

20. The method of claim 14, wherein displaying information associated with an organization member comprises displaying a member profile associated with an organization member.
